(19) United States
(12) Patent Application Publication
(10) Pub. No.: US 2013/0147201 A1
(43) Pub. Date: Jun. 13, 2013

(54) CONTACTLESS POWER TRANSFER DEVICE AND METHOD

(71) Applicants: Robert ROESNER, Unterfoehring (DE); Parag Rameshchandra DHARMADHIKARI, Neufahrn (DE)

(72) Inventors: Robert ROESNER, Unterfoehring (DE); Parag Rameshchandra DHARMADHIKARI, Neufahrn (DE)

(21) Appl. No.: 13/324,387

(22) Filed: Dec. 13, 2011

(51) Int. Cl. F03D 9/00; H01F 38/14

(52) U.S. Cl. 290/55; 307/104

(57) ABSTRACT

A contactless power transfer device for transferring electrical power from a nacelle to a hub of a wind turbine is provided. The power transfer device includes power input terminals arranged at the nacelle for inputting electrical input power and power output terminals arranged at the hub for outputting electrical output power. A wound rotor radial flux electrical machine is provided which has at least one stationary winding electrically connected to the power input terminals and arranged at a stationary component coupled to the nacelle, and at least one rotatable winding electrically connected to the power output terminals and arranged at a rotatable component coupled to the hub, for converting the electrical input power into the electrical output power.

### BACKGROUND OF THE INVENTION

The subject matter described herein relates generally to methods and systems for operating electrical devices in a wind turbine, and more particularly, to methods and systems for transferring electrical power from a nacelle to a rotor hub of the wind turbine.

Generally, a wind turbine includes a turbine that has a rotor that includes a rotatable hub assembly having multiple blades. The blades transform wind energy into a mechanical rotational torque that drives one or more generators via the rotor. The generators are sometimes, but not always, rotationally coupled to the rotor through a gearbox. The gearbox steps up the inherently low rotational speed of the rotor for the generator to efficiently convert the rotational mechanical energy to electrical energy, which is fed into a utility grid via at least one electrical connection. Gearless direct drive wind turbines also exist. The rotor, generator, gearbox and other components are typically mounted within a housing, or nacelle, that is positioned on top of a base that may be a truss or tubular tower.

Some wind turbine configurations include double-fed induction generators (DFIGs) for the production of electrical energy. Such configurations may also include power converters that are used to convert a frequency of generated electrical power to a frequency substantially similar to a utility grid frequency. Moreover, such converters, in conjunction with the DFIG, also transmit electrical power between the utility grid and the generator as well as transmit generator excitation power to a wound generator rotor from one of the connections to the electrical utility grid connection. Alternatively, some wind turbine configurations include, but are not limited to, alternative types of induction generators, permanent magnet (PM) synchronous generators and electrically-excited synchronous generators and switched reluctance generators. These alternative configurations may also include power converters that are used to convert the frequencies as described above and transmit electrical power between the utility grid and the generator.

Known wind turbines have a plurality of mechanical and electrical components. Each electrical and/or mechanical component may have independent or different operating limitations, such as current, voltage, power, and/or temperature limits, than other components. Moreover, known wind turbines typically are designed and/or assembled with predefined rated power limits. To operate within such rated power limits, the electrical and/or mechanical components may be operated with large margins for the operating limitations. Such operation may result in inefficient wind turbine operation, and a power generation capability of the wind turbine may be underutilized.

In a hub of a wind turbine, electrical devices are arranged which are supplied with electrical power. The electrical devices include e.g. pitch motors, plate position control, electronic control devices etc. During operation of the wind turbine, a transfer of electrical power and communication signals for controlling components of the wind turbine may be transferred between a stationary component, i.e. the nacelle of the wind turbine, and a rotatable component, i.e. the rotor hub. Power transfer in many cases is typically provided by a slip ring which provides an electrical contact between terminals arranged at the nacelle and electrical terminals arranged at the hub such that a power transfer may be provided during the rotation of the rotor hub. Slip ring arrangements, however, are complicated to set-up and sometimes only provide unreliable power transfer. Thus, the cost of quality, such as cost of repairs, maintenance, replacement and revenue loss due to up-down times of the wind turbine, increase in case of slip ring failures. In order to provide electrical power for electrical and electronic components which are arranged within the rotatable hub, a reliable power transfer by means of a rugged device is desired.

### BRIEF DESCRIPTION OF THE INVENTION

In one aspect, a contactless power transfer device for transferring electrical power from a nacelle to a hub of a wind turbine is provided, the contactless power transfer device including power input terminals arranged at the nacelle for inputting electrical input power, power output terminals arranged at the hub for outputting electrical output power, and a wound rotor radial flux electrical machine having at least one stationary component and at least one rotatable component, wherein the stationary component is coupled to the nacelle and has at least one stationary winding connected to the power input terminals, and wherein the rotatable component is coupled to the hub and has at least one rotatable winding connected to the power output terminals.

In another aspect, a wind turbine is provided including a contactless power transfer device for transferring electrical power from a nacelle to a hub of said wind turbine, the contactless power transfer device including power input terminals arranged at the nacelle for inputting electrical input power, power output terminals arranged at the hub for outputting electrical output power, and a wound rotor radial flux electrical machine having at least one stationary component and at least one rotatable component, wherein the stationary component is coupled to the nacelle and has at least one stationary winding connected to the power input terminals, and wherein the rotatable component is coupled to the hub and has at least one rotatable winding connected to the power output terminals.

In yet another aspect, a method for transferring electrical power from a nacelle to a hub of a wind turbine during operation of the wind turbine is provided, the method including providing electrical input power at the nacelle, transferring at least a portion of the electrical input power from the nacelle to the hub via a wound rotor radial flux electrical machine, receiving the transferred electrical power at the hub, and outputting the received electrical power as electrical output power.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of a portion of an exemplary wind turbine.

FIG. 2 is a schematic view of an exemplary electrical and control system suitable for use with the wind turbine shown in FIG. 1.

FIG. 3 is a schematic block diagram of a system for power and data transfer between a nacelle and a hub of a wind turbine according to a typical embodiment.

FIG. 4 is a schematic drawing of an arrangement of a contactless power transfer device with respect to a rotor shaft of the wind turbine according to a typical embodiment.

FIG. 5 is a schematic configuration of an equivalent circuit of a wound rotor radial flux electrical machine, according to another typical embodiment.

FIG. 6 is a flowchart illustrating a method for transferring electrical power from a nacelle to a hub of a wind turbine during operation of the wind turbine.

FIG. 7 is a flowchart illustrating a method for transferring electrical power from a nacelle to a hub of a wind turbine during operation of the wind turbine, according to a further typical embodiment.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a wind turbine system that provides electrical power transfer from a nacelle to a rotatable hub of the wind turbine. More specifically, a transfer of electrical power is provided by a contactless means, such as an induction motor or an induction machine such as a wound rotor radial flux electrical machine. An induction motor is based on a power transfer without slip rings or galvanic contact such as brush contacts. The induction motor includes a stationary component stator coupled to the nacelle and a rotatable component coupled to the hub. Both the stationary component and the rotatable may include at least one set of windings which provide inductive transfer of electrical energy. According to a typical embodiment, the stationary component may be coupled to the nacelle and may include at least one stationary winding connected to power input terminals, wherein the rotatable component may be coupled to the hub and may include least one rotatable winding connected to the power output terminals

As used herein, the term “stationary component” is intended to be representative of a component of the contactless power transfer device which is located in the nacelle of the wind turbine, i.e. the term “stationary component” is intended to be representative of a component of the contactless power transfer device which is not rotating. On the other hand, as used herein, the term “rotatable component” is intended to be representative of a component of the contactless power transfer device which is located in the rotor hub of the wind turbine, i.e. the term “rotatable component” is intended to be representative of a component of the contactless power transfer device which is rotatable, e.g. with the hub. As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

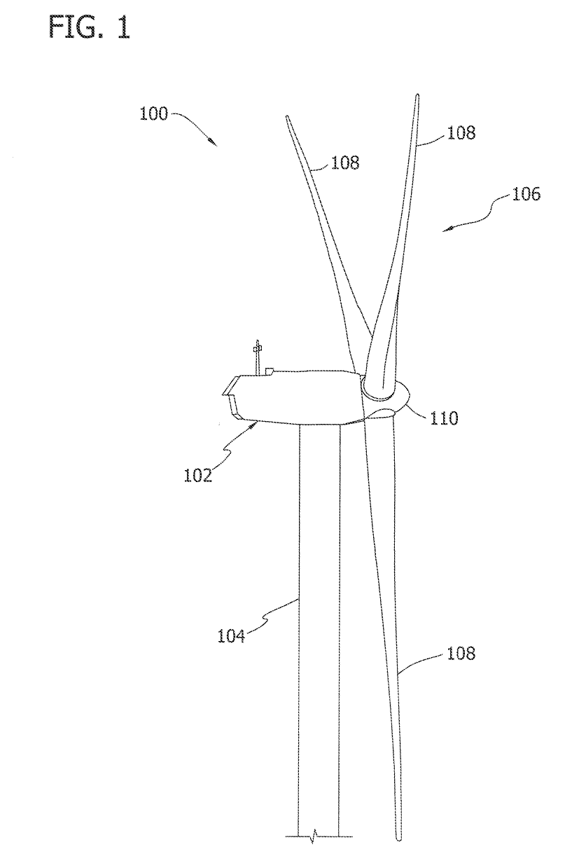

FIG. 1 is a perspective view of a portion of an exemplary wind turbine 100. Wind turbine 100 includes a nacelle 102 housing a generator (not shown in FIG. 1). Nacelle 102 is mounted on a tower 104 (a portion of tower 104 being shown in FIG. 1). Tower 104 may have any suitable height that facilitates operation of wind turbine 100 as described herein. Wind turbine 100 also includes a rotor 106 that includes three blades 108 attached to a rotatable hub 110. Alternatively, wind turbine 100 includes any number of blades 108 that facilitates operation of wind turbine 100 as described herein. In the exemplary embodiment, wind turbine 100 includes a gearbox (not shown in FIG. 1) operatively coupled to rotor 106 and a generator (not shown in FIG. 1).

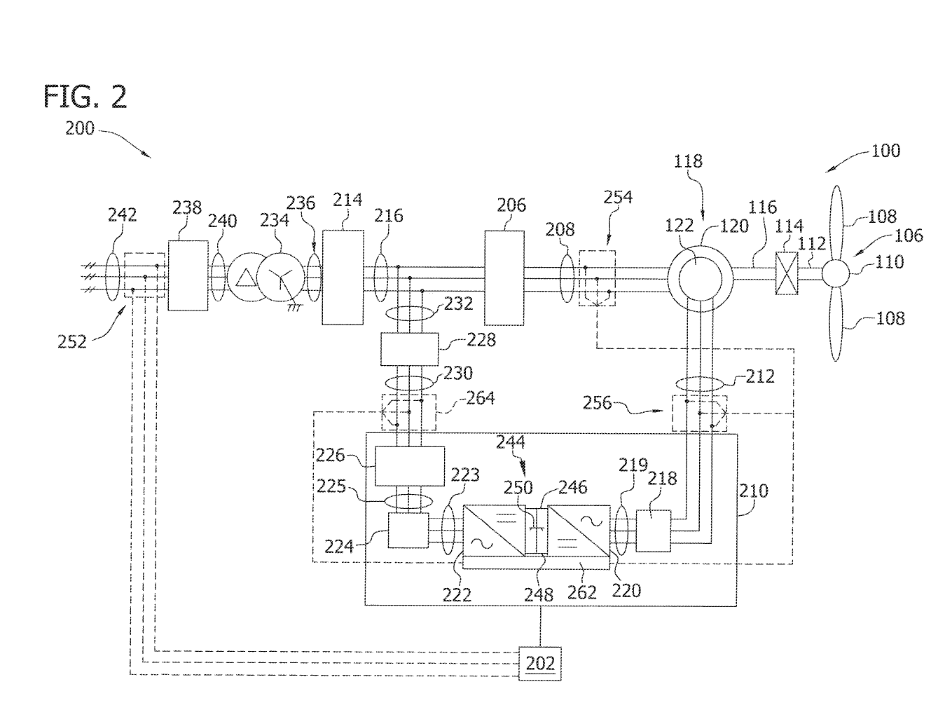

FIG. 2 is a schematic view of an exemplary electrical and control system 200 that may be used with wind turbine 100. Rotor 106 includes blades 108 coupled to hub 110. Rotor 106 also includes a low-speed shaft 112 rotatably coupled to hub 110. Low-speed shaft 112 is coupled to a step-up gearbox 114 that is configured to step up the rotational speed of low-speed shaft 112 and transfer that speed to a high-speed shaft 116. In the exemplary embodiment, gearbox 114 has a step-up ratio of approximately 70:1. For example, low-speed shaft 112 rotating at approximately 20 revolutions per minute (rpm) coupled to gearbox 114 with an approximately 70:1 step-up ratio generates a speed for high-speed shaft 116 of approximately 1400 rpm. Alternatively, gearbox 114 has any suitable step-up ratio that facilitates operation of wind turbine 100 as described herein. As a further alternative, wind turbine 100 includes a direct-drive generator that is rotatably coupled to rotor 106 without any intervening gearbox.

High-speed shaft 116 is rotatably coupled to generator 118. In the exemplary embodiment, generator 118 is a wound rotor, three-phase, double-fed induction (asynchronous) generator (DFIG) that includes a generator stator 120 magnetically coupled to a generator rotor 122. In an alternative embodiment, generator rotor 122 includes a plurality of permanent magnets in place of rotor windings.

Electrical and control system 200 includes a turbine controller 202. Turbine controller 202 includes at least one processor and a memory, at least one processor input channel, at least one processor output channel, and may include at least one computer (none shown in FIG. 2). As used herein, the term computer is not limited to integrated circuits referred to in the art as a computer, but broadly refers to a processor, a microcontroller, a microcomputer, a programmable logic controller (PLC), an application specific integrated circuit, and other programmable circuits (none shown in FIG. 2), and these terms are used interchangeably herein. In the exemplary embodiment, memory may include, but is not limited to, a computer-readable medium, such as a random access memory (RAM) (none shown in FIG. 2). Alternatively, one or more storage devices, such as a floppy disk, a compact disc read only memory (CD-ROM), a magneto-optical disk (MOD), and/or a digital versatile disc (DVD) (none shown in FIG. 2) may also be used. Also, in the exemplary embodiment, additional input channels (not shown in FIG. 2) may be, but are not limited to, computer peripherals associated with an operator interface such as a mouse and a keyboard (neither shown in FIG. 2). Further, in the exemplary embodiment, additional output channels may include, but are not limited to, an operator interface monitor (not shown in FIG. 2).

Processors for turbine controller 202 process information transmitted from a plurality of electrical and electronic devices that may include, but are not limited to, voltage and current transducers. RAM and/or storage devices store and transfer information and instructions to be executed by the processor. RAM and/or storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

Generator stator 120 is electrically coupled to a stator synchronizing switch 206 via a stator bus 208. In an exemplary embodiment, to facilitate the DFIG configuration, generator rotor 122 is electrically coupled to a bi-directional power conversion assembly 210 via a rotor bus 212. Alternatively, generator rotor 122 is electrically coupled to rotor bus 212 via any other device that facilitates operation of electrical and control system 200 as described herein. As a further alternative, electrical and control system 200 is configured as a full power conversion system (not shown) that includes a full power conversion assembly (not shown in FIG. 2) similar in design and operation to power conversion assembly 210 and electrically coupled to generator stator 120. The full power conversion assembly facilitates channeling electric power between generator stator 120 and an electric power transmission and distribution grid (not shown). In the exemplary embodiment, stator bus 208 transmits three-phase power from generator stator 120 to stator synchronizing switch 206. Rotor bus 212 transmits three-phase power from generator rotor 122 to power conversion assembly 210. In the exemplary embodiment, stator synchronizing switch 206 is electrically coupled to a main transformer circuit breaker 214 via a system bus 216. In an alternative embodiment, one or more fuses (not shown) are used instead of main transformer circuit breaker 214. In another embodiment, neither fuses nor main transformer circuit breaker 214 is used.

Power conversion assembly 210 includes a rotor filter 218 that is electrically coupled to generator rotor 122 via rotor bus 212. A rotor filter bus 219 electrically couples rotor filter 218 to a rotor-side power converter 220, and rotor-side power converter 220 is electrically coupled to a line-side power converter 222. Rotor-side power converter 220 and line-side power converter 222 are power converter bridges including power semiconductors (not shown). In the exemplary embodiment, rotor-side power converter 220 and line-side power converter 222 are configured in a three-phase, pulse width modulation (PWM) configuration including insulated gate bipolar transistor (IGBT) switching devices (not shown in FIG. 2) that operate as known in the art. Alternatively, rotor-side power converter 220 and line-side power converter 222 have any configuration using any switching devices that facilitate operation of electrical and control system 200 as described herein. Power conversion assembly 210 is coupled in electronic data communication with turbine controller 202 to control the operation of rotor-side power converter 220 and line-side power converter 222.

In the exemplary embodiment, a line-side power converter bus 223 electrically couples line-side power converter 222 to a line filter 224. Also, a line bus 225 electrically couples line filter 224 to a line contactor 226. Moreover, line contactor 226 is electrically coupled to a conversion circuit breaker 228 via a conversion circuit breaker bus 230. In addition, conversion circuit breaker 228 is electrically coupled to main transformer circuit breaker 214 via system bus 216 and a connection bus 232. Alternatively, line filter 224 is electrically coupled to system bus 216 directly via connection bus 232 and includes any suitable protection scheme (not shown) configured to account for removal of line contactor 226 and conversion circuit breaker 228 from electrical and control system 200. Main transformer circuit breaker 214 is electrically coupled to an electric power main transformer 234 via a generator-side bus 236. Main transformer 234 is electrically coupled to a grid circuit breaker 238 via a breaker-side bus 240. Grid circuit breaker 238 is connected to the electric power transmission and distribution grid via a grid bus 242. In an alternative embodiment, main transformer 234 is electrically coupled to one or more fuses (not shown), rather than to grid circuit breaker 238, via breaker-side bus 240. In another embodiment, neither fuses nor grid circuit breaker 238 is used, but rather main transformer 234 is coupled to the electric power transmission and distribution grid via breaker-side bus 240 and grid bus 242.

In the exemplary embodiment, rotor-side power converter 220 is coupled in electrical communication with line-side power converter 222 via a single direct current (DC) link 244. Alternatively, rotor-side power converter 220 and line-side power converter 222 are electrically coupled via individual and separate DC links (not shown in FIG. 2). DC link 244 includes a positive rail 246, a negative rail 248, and at least one capacitor 250 coupled between positive rail 246 and negative rail 248. Alternatively, capacitor 250 includes one or more capacitors configured in series and/or in parallel between positive rail 246 and negative rail 248.

Turbine controller 202 is configured to receive a plurality of voltage and electric current measurement signals from a first set of voltage and electric current sensors 252. Moreover, turbine controller 202 is configured to monitor and control at least some of the operational variables associated with wind turbine 100. In the exemplary embodiment, each of three voltage and electric current sensors 252 are electrically coupled to each one of the three phases of grid bus 242. Alternatively, voltage and electric current sensors 252 are electrically coupled to system bus 216. As a further alternative, voltage and electric current sensors 252 are electrically coupled to any portion of electrical and control system 200 that facilitates operation of electrical and control system 200 as described herein. As a still further alternative, turbine controller 202 is configured to receive any number of voltage and electric current measurement signals from any number of voltage and electric current sensors 252 including, but not limited to, one voltage and electric current measurement signal from one transducer.

As shown in FIG. 2, electrical and control system 200 also includes a converter controller 262 that is configured to receive a plurality of voltage and electric current measurement signals. For example, in one embodiment, converter controller 262 receives voltage and electric current measurement signals from a second set of voltage and electric current sensors 254 coupled in electronic data communication with stator bus 208. Converter controller 262 receives a third set of voltage and electric current measurement signals from a third set of voltage and electric current sensors 256 coupled in electronic data communication with rotor bus 212. Converter controller 262 also receives a fourth set of voltage and electric current measurement signals from a fourth set of voltage and electric current sensors 264 coupled in electronic data communication with conversion circuit breaker bus 230. Second set of voltage and electric current sensors 254 is substantially similar to first set of voltage and electric current sensors 252, and fourth set of voltage and electric current sensors 264 is substantially similar to third set of voltage and electric current sensors 256. Converter controller 262 is substantially similar to turbine controller 202 and is coupled in electronic data communication with turbine controller 202. Moreover, in the exemplary embodiment, converter controller 262 is physically integrated within power conversion assembly 210. Alternatively, converter controller 262 has any configuration that facilitates operation of electrical and control system 200 as described herein.

During operation, wind impacts blades 108 and blades 108 transform wind energy into a mechanical rotational torque that rotatably drives low-speed shaft 112 via hub 110. Low-speed shaft 112 drives gearbox 114 that subsequently steps up the low rotational speed of low-speed shaft 112 to drive high-speed shaft 116 at an increased rotational speed. High speed shaft 116 rotatably drives generator rotor 122. A rotating magnetic field is induced by generator rotor 122 and a voltage is induced within generator stator 120 that is magnetically coupled to generator rotor 122. Generator 118 converts the rotational mechanical energy to a sinusoidal, three-phase alternating current (AC) electrical energy signal in generator stator 120. The associated electrical power is transmitted to main transformer 234 via stator bus 208, stator synchronizing switch 206, system bus 216, main transformer circuit breaker 214 and generator-side bus 236. Main transformer 234 steps up the voltage amplitude of the electrical power and the transformed electrical power is further transmitted to a grid via breaker-side bus 240, grid circuit breaker 238 and grid bus 242.

In the exemplary embodiment, a second electrical power transmission path is provided. Electrical, three-phase, sinusoidal, AC power is generated within generator rotor 122 and is transmitted to power conversion assembly 210 via rotor bus 212. Within power conversion assembly 210, the electrical power is transmitted to rotor filter 218 and the electrical power is modified for the rate of change of the PWM signals associated with rotor-side power converter 220. Rotor-side power converter 220 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple associated with AC rectification.

The DC power is subsequently transmitted from DC link 244 to line-side power converter 222 and line-side power converter 222 acts as an inverter configured to convert the DC electrical power from DC link 244 to three-phase, sinusoidal AC electrical power with pre-determined voltages, currents, and frequencies. This conversion is monitored and controlled via converter controller 262. The converted AC power is transmitted from line-side power converter 222 to system bus 216 via line-side power converter bus 223 and line bus 225, line contactor 226, conversion circuit breaker bus 230, conversion circuit breaker 228, and connection bus 232. Line filter 224 compensates or adjusts for harmonic currents in the electric power transmitted from line-side power converter 222. Stator synchronizing switch 206 is configured to close to facilitate connecting the three-phase power from generator stator 120 with the three-phase power from power conversion assembly 210.

Conversion circuit breaker 228, main transformer circuit breaker 214, and grid circuit breaker 238 are configured to disconnect corresponding buses, for example, when excessive current flow may damage the components of electrical and control system 200. Additional protection components are also provided including line contactor 226, which may be controlled to form a disconnect by opening a switch (not shown in FIG. 2) corresponding to each line of line bus 225.

Power conversion assembly 210 compensates or adjusts the frequency of the three-phase power from generator rotor 122 for changes, for example, in the wind speed at hub 110 and blades 108. Therefore, in this manner, mechanical and electrical rotor frequencies are decoupled from stator frequency.

Under some conditions, the bi-directional characteristics of power conversion assembly 210, and specifically, the bi-directional characteristics of rotor-side power converter 220 and line-side power converter 222, facilitate feeding back at least some of the generated electrical power into generator rotor 122. More specifically, electrical power is transmitted from system bus 216 to connection bus 232 and subsequently through conversion circuit breaker 228 and conversion circuit breaker bus 230 into power conversion assembly 210. Within power conversion assembly 210, the electrical power is transmitted through line contactor 226, line bus 225, and line-side power converter bus 223 into line-side power converter 222. Line-side power converter 222 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple sometimes associated with three-phase AC rectification.

The DC power is subsequently transmitted from DC link 244 to rotor-side power converter 220 and rotor-side power converter 220 acts as an inverter configured to convert the DC electrical power transmitted from DC link 244 to a three-phase, sinusoidal AC electrical power with pre-determined voltages, currents, and frequencies. This conversion is monitored and controlled via converter controller 262. The converted AC power is transmitted from rotor-side power converter 220 to rotor filter 218 via rotor filter bus 219 and is subsequently transmitted to generator rotor 122 via rotor bus 212, thereby facilitating sub-synchronous operation.

Power conversion assembly 210 is configured to receive control signals from turbine controller 202. The control signals are based on sensed conditions or operating characteristics of wind turbine 100 and electrical and control system 200. The control signals are received by turbine controller 202 and used to control operation of power conversion assembly 210. Feedback from one or more sensors may be used by electrical and control system 200 to control power conversion assembly 210 via converter controller 262 including, for example, conversion circuit breaker bus 230, stator bus and rotor bus voltages or current feedbacks via second set of voltage and electric current sensors 254, third set of voltage and electric current sensors 256, and fourth set of voltage and electric current sensors 264. Using this feedback information, and for example, switching control signals, stator synchronizing switch control signals and system circuit breaker control (trip) signals may be generated in any known manner. For example, for a grid voltage transient with predetermined characteristics, converter controller 262 will at least temporarily substantially suspend the IGBTs from conducting within line-side power converter 222. Such suspension of operation of line-side power converter 222 will substantially mitigate electric power being channeled through power conversion assembly 210 to approximately zero.

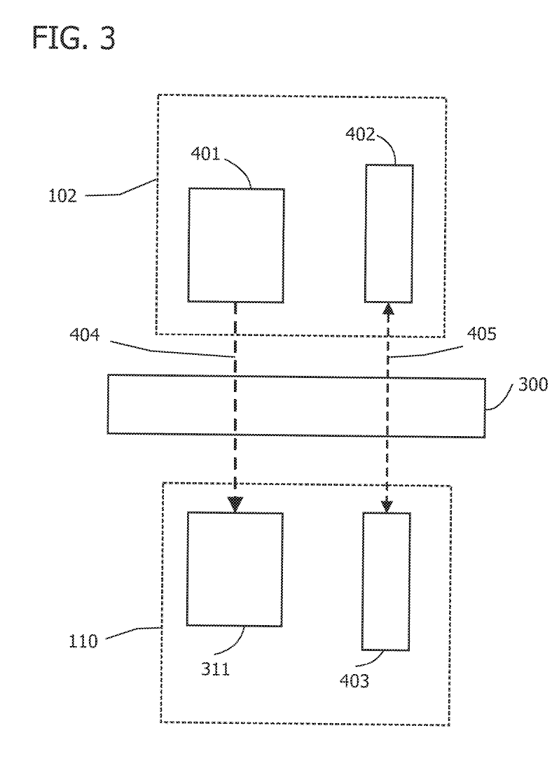

FIG. 3 is a block diagram of a transfer device for contactless transfer of electrical power and communication signals from the nacelle 102 to the hub 110 of the wind turbine 100. As shown in FIG. 3, electrical power 404 and communication signals 405 are transferred between the hub 110 and the nacelle 102 via a contactless power transfer device 300 including a wound rotor radial flux electrical machine (wound rotor electrical machine). For providing contactless power transfer, the nacelle 102 includes a power supply 401 which is connected to the contactless power transfer device 300. On the other hand, a power converter 311 arranged within the hub 110 of the wind turbine 100 is connected to an output side of the contactless power transfer device 300. As the power transfer device 300 includes the wound rotor radial flux electrical machine, a contactless power transfer between a stationary component, e.g. the nacelle 102 of the wind turbine 100 and a rotatable component, e.g. the hub 110 of the wind turbine 100, may be provided. A frequency of the electrical input power may be provided by means of the converter or an inverter, and a frequency of the electrical output power may vary in accordance with the frequency of the electrical input power when the wind turbine is rotating. Outputting the received electrical power may include outputting the received electrical power at an output frequency different from a frequency of the electrical input power.

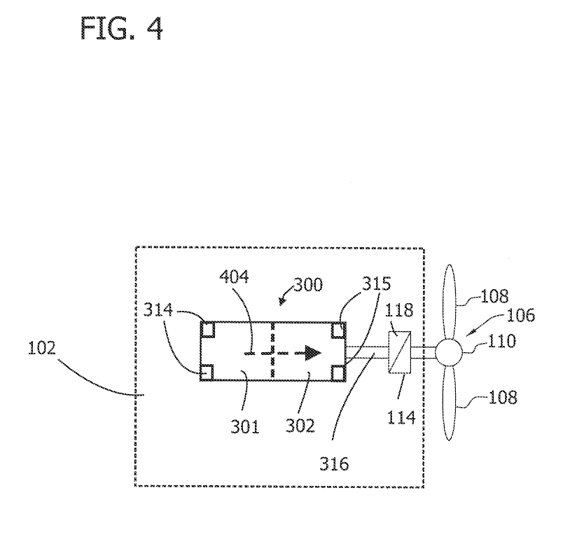

Furthermore, a nacelle-based transceiver module 402 is shown to be arranged within the nacelle 102. The nacelle-based transceiver module 402 may be used for communicating control signals via the power transfer device 300. At the rotatable component, i.e. at the hub 110 of the wind turbine, a corresponding hub-based transceiver module 403 is arranged which may communicate control signals via the power transfer device 300. The contactless power transfer device 300 which may include the wound rotor radial flux electrical machine will be described herein below with respect to FIG. 4. Besides transfer of communication signals via the contactless power transfer device 300, communication and/or control signals may be transferred via IR links, Bluetooth, WLAN, or other appropriate wireless systems.

It is noted here, although not shown in FIG. 3, that the power supply may be represented by a utility grid which is connected to components and systems within the nacelle 102 of the wind turbine 100. The power converter 311 provides electrical power for electrical and electronic components within the hub 110, wherein the electrical power provided by the power converter 311 is in a range from 5 kVA to 20 kVA, typically in a range from 8 kVA to 14 kVA, and more typically amounts to approximately 11 kVA.

It is noted here, although the main application for the power transfer device 300 according to typical embodiments is a power transfer from the nacelle 102 to the hub 110 of the wind turbine 100, a power transfer from the hub 110 to the nacelle 102 of the wind turbine may be provided as well.

FIG. 4 is a schematic drawing illustrating the set-up of the contactless power transfer device 300 within the nacelle 102 of the wind turbine 100. As shown in FIG. 4, the power transfer device 300 includes a stationary component 301 and a rotatable component 302. According to a typical embodiment the stationary component 301 may be fixedly mounted at the nacelle, wherein the rotatable component 302 may be coupled to a rotor shaft 316 of the rotor of the wind turbine 100 and may thus rotate together with the rotor. The rotor shaft is connected to the generator 118 which in turn may be coupled to a gearbox 114 which can be provided optionally. The low speed shaft 112 (see FIG. 2) may be connected through the generator 118 and the gearbox 114 to the rotatable component 302. Thereby, the rotor shaft 316 rotates with the hub 110 having attached thereon the rotor blades 108 to the rotor 106. The power transfer device 300 is designed for transferring electrical power 404 from the nacelle 102 to the hub 110 of the wind turbine 100.

In other words, electrical input power which is applied at power input terminals 314 of the contactless power transfer device 300 is inductively coupled from the stationary component 301 to the rotatable component 302 such that transferred electrical input power may be output from output terminals 315 provided at the rotatable component 302. The contactless power transfer device 300 may include a wound rotor radial flux electrical machine having at least one stationary winding electrically connected to the power input terminals 314 and arranged at the stationary component 301 coupled to the nacelle 102, and at least one rotatable winding electrically connected to the power output terminals 315 and arranged at the rotatable component 302 coupled to the hub 110. Thus, the electrical input power may be converted into the electrical output power. In order to provide an efficient power transfer between the nacelle 102 and the hub 110 of the wind turbine 100, no particular alignment except the rotation axis set-up of the wound rotor radial flux electrical machine in an alignment with the axis of the rotor shaft 316 may be provided. The wound rotor radial flux electrical machine may include at least one stationary component 301 and at least one rotatable component 302, wherein the stationary component 301 is coupled to the nacelle 102 and has at least one stationary winding connected to the power input terminals, and wherein the rotatable component 302 is coupled to the hub 110 and has at least one rotatable winding connected to the power output terminals.

The wound rotor radial flux electrical machine may be formed of at least one of a doubly-fed electrical machine, an asynchronous wound rotor induction machine, an external rotor electrical machine, and any combination thereof As the wound rotor radial flux electrical machine is not mechanically driven by the electrical input power, but by the rotation of the rotor 106 of the wind turbine 100, the form of power at the input and the output of the wound rotor radial flux electrical machine is not changed, i.e. electrical input power provided at the power input terminals 314 arranged at the nacelle 102 is converted into electrical output power provided at the power output terminals 315 which are rotating with the hub 110. Moreover, a frequency converter may be provided which may be connected to the input terminals or the output terminals.

Although not shown in FIG. 4, besides the transfer of electrical power from the stationary component 301 to the rotatable component 302, communication signal transfer 405 may be provided via induction between at least one stationary winding provided at the stationary component and at least one rotatable winding provided at the rotatable component. In accordance with the rotation of the rotor 106 of the wind turbine 100, at least one rotatable winding arranged at the rotatable component 302 of the contactless power transfer device 300 can be rotated with respect to the at least one stationary winding arranged at the stationary component 301 of the power transfer device 300.

A power rating of the wound rotor radial flux electrical machine which is included in the power transfer device 300 may be in a range from 5 kVA to 20 kVA, typically from 8 kVA to 14 kVA, and more typically the power rating amounts to approximately 11 kVA. The axis of the wound rotor radial flux electrical machine provided in the power transfer device 300 may be arranged such that the rotation axis of the machine approximately coincides with an axis of the rotor shaft 316 of the rotor of the wind turbine.

According to a typical embodiment described herein, wind turbines 100 having electrical pitch control mechanisms for plate position control include a power transfer device 300 for transfer of electrical power from the nacelle 102 as stationary component 301 to the hub 110 as rotatable component 302. Thereby, the plate position may be controlled. Furthermore, besides power transfer communication signal transfer may be achieved. By using a wound rotor radial flux electrical machine for power and signal transfer, failures occurring when using slip rings and cost of maintenance may be reduced. According to a typical embodiment, which may be combined with other embodiments described herein, an induction machine with wound rotor may be provided for contactless power and signal transfer. The power rating of the radial flux electrical machine may be adapted to the power requirements of electrical and electronic components in the hub 110 and according to losses in the transfer of electrical power from the nacelle 102 to the hub 110 of the wind turbine 100.

As indicated in FIG. 4, the positioning of the contactless power transfer device 300 may be provided at the end of the rotor shaft 316. A shaft of the wound rotor radial flux electrical machine may be connected to the turbine rotor connected to the hub, and a stator of the machine may be a fixed part with AC power excitation to at least one stationary winding within the nacelle 102. The wound rotor induction radial flux electrical machine may be used as contactless power supply for components mounted in the hub 110. According to a typical embodiment, a machine stator may be located at a stationary component 301 in the nacelle of the wind turbine. On the other hand, a machine rotor may be located at a rotatable component 302, e.g. in the rotor hub of the wind turbine. Thereby, the stationary component 301 may be a machine stator of the wound rotor radial flux electrical machine, and the rotatable component 302 may be a machine rotor of the wound rotor radial flux electrical machine. According to yet another typical embodiment which may be combined with other embodiments described herein, the stationary component 301 may be a machine rotor of the wound rotor radial flux electrical machine, and the rotatable component 302 may be a machine stator of the wound rotor radial flux electrical machine. The AC power may be provided for electrical and electronic components within the hub 110 and may then be processed for further use, e.g. for powering axis boxes and battery chargers.

According to the schematic set-up shown in FIG. 4, the input terminals 314 of the power transfer device 300 are stationary, wherein the output terminals 315 of the power transfer device 300 are rotating together with the rotor shaft 316. Thus, electrical power may be transferred between a stationary subsystem, i.e. the nacelle 102 having fixed thereon the stationary component 301 of the power transfer device 300, and a rotatable subsystem that is rotating with the rotor hub 110 of the rotor 106. The rotatable component 302 is thus connected to the rotatable subsystem. It is noted here that the components shown in FIG. 4 and the respective coupling arrangements are not drawn to scale.

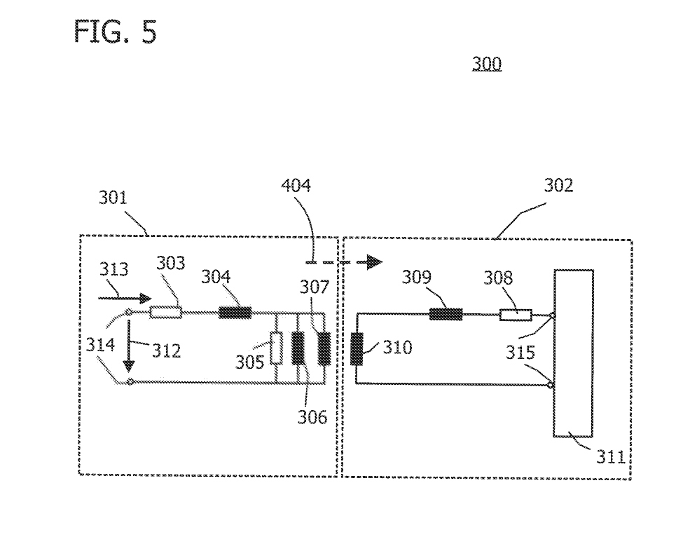

FIG. 5 is a circuit diagram of an equivalent circuit of a wound rotor radial flux electrical machine which may be used in the contactless power transfer device 300 described herein above. The equivalent circuit of the wound rotor radial flux electrical machine of the power transfer device 300 includes, at its stationary component 301, the input terminals 314, where the input voltage 312 is applied. An input current 313 flows via a series resistor 303 and a series inductance 304 to a parallel circuit including a parallel resistor 305 and a parallel inductance 306. At least one stationary winding 307 is connected in parallel to the parallel circuit 305, 306. The stationary winding 307 is inductively coupled to at least one rotatable winding 310 provided at the rotatable component 302 of the wound rotor radial flux electrical machine. Power transferred from the stationary component 301 to the rotatable component 302, i.e. an appropriate power transfer 404, results in an output power provided at the output terminals 315 of the rotatable component 302. The rotatable component 302 includes, in a series connection to the rotatable winding 310, a rotor series resistor 308 and a rotor series inductance 309.

As shown in FIG. 5, the output terminals 315 are connected to a power converter 311 which is used e.g. for converting output power into a form of electrical power which is used by electrical and electronic components arranged within the hub 110 within the wind turbine 100.

According to another typical embodiment, which may be combined with other embodiments described herein, a frequency converter may be provided which is electrically connected to the power input terminals 314 and/or to the power output terminals 315 and adapted for varying a frequency of the transferred electrical power. It is noted here, although not shown in the schematic equivalent circuit diagram of FIG. 5, that the wound rotor radial flux electrical machine may include poly-phase stationary windings and/or poly-phase rotatable windings. The wound rotor radial flux electrical machine provided as an induction motor may be designed as a motor having three phases, i.e. any poly-phase arrangement may be provided. Furthermore, the electrical machine may be designed as a machine having less than three or more than three phases. The rotor-side power converter 311 may act as a rectifier and may rectify sinusoidal AC power in order to provide DC power.

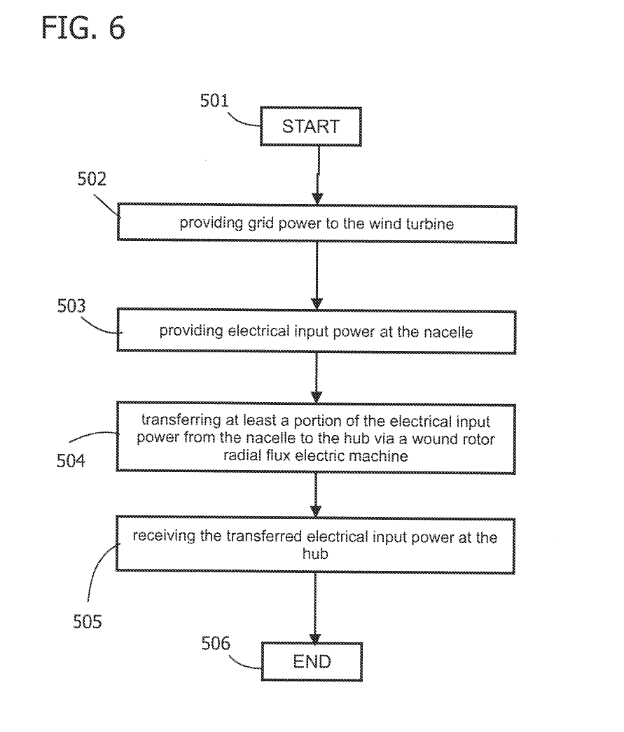

FIG. 6 is a flowchart illustrating a method for transferring electrical power from a nacelle to a hub of a wind turbine during operation of the wind turbine. The procedure illustrated in FIG. 6 starts at a block 501. Then, the wind turbine is operated and electrical grid power is provided to the wind turbine (block 502). Electrical input power may be provided at the nacelle 102, e.g. at the input terminals 314 of the contactless power transfer device 300, as shown in block 503.

Then, at least a portion of the electrical input power may be transferred from the nacelle 102 to the hub 110 via a wound rotor radial flux electrical machine (block 504). The transferred electrical input power may be received at the hub 102 (block 505), and the procedure is ended at a block 506.

When transferring the electrical input power from the nacelle 102 to the hub 110, the hub 110 may rotate. Alternatively, when transferring the electrical input power from the nacelle 102 to the hub 110, the hub 110 may be stationary. Moreover, positive or negative torque may be applied at the hub of the wind turbine by means of the wound rotor radial flux electrical machine when transferring power to the hub. In other words, torque may be transferred from the stationary component to the rotatable component when transferring power to the hub, or torque may be transferred from the rotatable component to the stationary component when transferring power to the hub. The transferred electrical input power may be rectified in the hub 110. Furthermore, transferring the electrical input power from the nacelle 102 to the hub 110 of the wind turbine 100 via the wound rotor radial flux electrical machine may include transferring three phases of AC current, or less than three phases of AC current, or more than three phases of AC current.

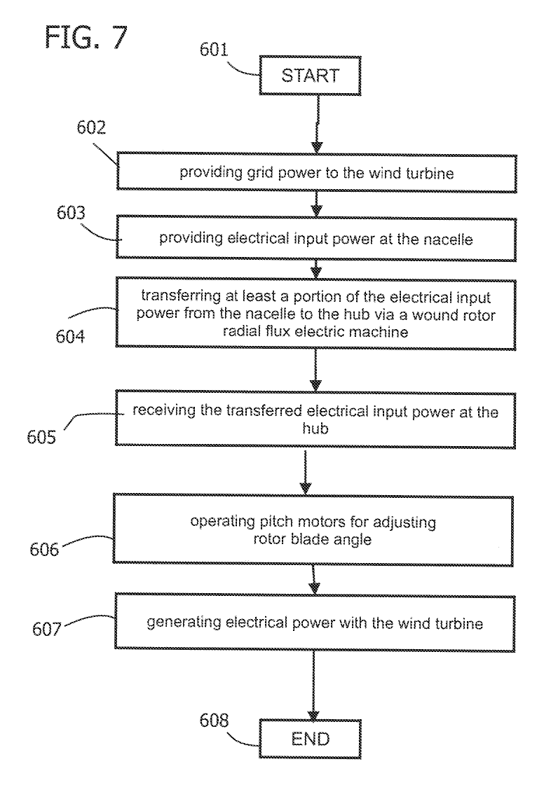

FIG. 7 is a flowchart illustrating a method for transferring electrical power from a nacelle to a hub of a wind turbine, according to a further typical embodiment. The procedure illustrated in FIG. 7 starts at a block 601. Then, the wind turbine is operated and electrical grid power is provided to the wind turbine (block 602). Electrical input power may be provided at the nacelle 102, e.g. at the input terminals 314 of the contactless power transfer device 300, as shown in block 603. Then, at least a portion of the electrical input power may be transferred from the nacelle 102 to the hub 110 via a wound rotor radial flux electrical machine (block 604). The transferred electrical input power may be received at the hub 102 (block 605). Using the transferred electrical input power, e.g. pitch motors may be operated in order to adjust at least one rotor blade angle (pitch angle) of at least one rotor blade of the wind turbine, as illustrated by block 606. Then, electrical power may be generated with the wind turbine (block 607). The procedure is ended at a block 608.

The frequency of the electrical input power may be adapted to the grid frequency of an electrical utility grid, and the frequency of the transferred electrical input power may be varied in accordance with ratings of electrical and electronic components arranged within the hub 102. During transferring the electrical input power from the nacelle 102 to the hub 110 via the wound rotor radial flux electrical machine, a frequency conversion from the stationary component to the rotatable component of the wound rotor radial flux electrical machine may be applied. Furthermore, in addition to or instead of transferring electrical input power from the nacelle 102 to the hub 110 via the wound rotor radial flux electrical machine, communication signals may be transferred contactlessly between the nacelle 102 and the hub 110.

The above-described systems and methods facilitate a power supply for electrical and electronic components in the rotatable hub 110 of a wind turbine 100. Using the contactless power transfer device 300 according to exemplary embodiments described herein, a reduction in the cost of quality and a higher reliability for electrical power transfer may be provided. The power transfer between a stationary and a rotatable component 302 may be provided by means of a rugged device. Furthermore, manufacturing of power transfer devices having wound rotor radial flux electrical machines may be facilitated. Thereby, according to typical embodiments described herein, a rugged power transfer device may be provided. Failures caused by slip rings are thus eliminated. A simplified procedure for assembling the unit compared to present complex arrangements for slip rings is achieved. Furthermore, the maintenance costs are reduced and enhanced lifetime of the contactless power transfer device as compared to slip ring arrangements is possible. Furthermore, an additional isolation between the stationary component 301 and the rotatable component 302 is achieved. Communication signals can be transferred through wireless devices, Bluetooth devices or PLCC.

The contactless power transfer device according to embodiments described herein provides contactless transfer of electrical power from a stationary component 301 to a rotatable component 302 of a wind turbine. The wound rotor induction radial flux electrical machine used in the contactless power transfer device 300 reduces costs and increases the reliability. Electrical power may be transferred while the rotor of the wind turbine is rotating. For example, electrical three phase sinusoidal, AC power may be transferred. Furthermore, communication signals used for data exchange may be transferred via the contactless power transfer device 300.

Exemplary embodiments of systems and methods for electrical power transfer in a wind turbine are described above in detail. The systems and methods are not limited to the specific embodiments described herein, but rather, components of the systems and/or steps of the methods may be utilized independently and separately from other components and/or steps described herein. For example, the contactless power transfer may be used in many applications where a direct connection via electrical cables is not possible, and is not limited to practice with only the wind turbine systems as described herein. Rather, the exemplary embodiment can be implemented and utilized in connection with many rotating machines applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A contactless power transfer device for transferring electrical power from a nacelle to a hub of a wind turbine, the contactless power transfer device comprising:
power input terminals arranged at the nacelle for inputting electrical input power;
power output terminals arranged at the hub for outputting electrical output power; and
a wound rotor radial flux electrical machine having at least one stationary component and at least one rotatable component, wherein the stationary component is coupled to the nacelle and has at least one stationary winding connected to the power input terminals, and wherein the rotatable component is coupled to the hub and has at least one rotatable winding connected to the power output terminals.

2. The device according to claim 1, wherein the wound rotor radial flux electrical machine is formed of at least one of a doubly-fed electrical machine, an asynchronous wound rotor induction machine, an external rotor electrical machine, and any combination thereof.

3. The device according to claim 1, further comprising a frequency converter electrically connected to the power output terminals and/or the power output terminals, for varying a frequency of the transferred electrical power.

4. The device according to claim 1, wherein the wound rotor radial flux electrical machine comprises poly-phase stationary windings and/or poly-phase rotatable windings.

5. The device according to claim 1, wherein a power rating of the wound rotor radial flux electrical machine is in a range from 5 kVA to 20 kVA.

6. A wind turbine, comprising:
a contactless power transfer device for transferring electrical power from a nacelle to a hub of said wind turbine, the contactless power transfer device comprising:
power input terminals arranged at the nacelle for inputting electrical input power;
power output terminals arranged at the hub for outputting electrical output power; and
a wound rotor radial flux electrical machine having at least one stationary component and at least one rotatable component, wherein the stationary component is coupled to the nacelle and has at least one stationary winding connected to the power input terminals, and wherein the rotatable component is coupled to the hub and has at least one rotatable winding connected to the power output terminals.

7. The wind turbine according to claim 6, the wind turbine further comprising a wind turbine rotor having a rotor shaft, wherein the wound rotor radial flux electrical machine is arranged such that a rotational axis of the electrical machine coincides with a rotational axis of the rotor shaft.

8. The wind turbine according to claim 6, further comprising at least one nacelle-based transceiver module and at least one hub-based transceiver module for communicating control signals via the wound rotor radial flux electrical machine.

9. The wind turbine e according to claim 6, wherein the wound rotor radial flux electrical machine is formed of at least one of a doubly-fed electrical machine, an asynchronous wound rotor induction machine, an external rotor electrical machine, and any combination thereof.

10. The wind turbine according to claim 6, wherein the wound rotor radial flux electrical machine comprises poly-phase stationary windings and/or poly-phase rotatable windings.

11. The wind turbine according to claim 6, wherein a power rating of the wound rotor radial flux electrical machine is in a range from 5 kVA to 20 kVA.

12. The wind turbine according to claim 6, wherein the stationary component is a machine stator of the wound rotor radial flux electrical machine, and wherein the rotatable component is a machine rotor of the wound rotor radial flux electrical machine.

13. The wind turbine according to claim 6, wherein the stationary component is a machine rotor of the wound rotor radial flux electrical machine, and wherein the rotatable component is a machine stator of the wound rotor radial flux electrical machine.

14. A method for contactless transfer of electrical power from a nacelle to a hub of a wind turbine during operation of the wind turbine, the method comprising:
providing electrical grid input power at the nacelle of the wind turbine;
transferring at least a portion of the electrical input power from the nacelle to the hub via a wound rotor radial flux electrical machine;
receiving the transferred electrical power at the hub; and
outputting the received electrical power as electrical output power.

15. The method according to claim 14, wherein transferring the electrical input power from the nacelle to the hub is performed while the hub is rotating.

16. The method according to claim 14, further comprising rectifying the transferred electrical input power within the hub.

17. The method according to claim 14, wherein transferring the electrical input power from the nacelle to the hub via the wound rotor radial flux electrical machine comprises transferring polyphase AC current.

18. The method according to claim 14, wherein an input frequency of the electrical input power is the grid frequency of a utility grid and an output frequency of the transferred electrical input power is varied with respect to the input frequency when the wind turbine is rotating.

19. The method according to claim 14, wherein transferring the electrical input power from the nacelle to the hub via the wound rotor radial flux electrical machine comprises a frequency conversion from a stationary component to a rotatable component of the wound rotor radial flux electrical machine when the wind turbine rotor is rotating.

20. The method according to claim 14, wherein transferring the electrical input power from the nacelle to the hub via the wound rotor radial flux electrical machine comprises transferring communication signals between the nacelle and the hub.

21. The method according to claim 14, wherein positive or negative torque is applied at the hub of the wind turbine by means of the wound rotor radial flux electrical machine when transferring power to the hub.

22. The method according to claim 14, wherein outputting the received electrical power comprises outputting the received electrical power at an output frequency different from a frequency of the electrical input power.

23. The method according to claim 14, wherein a frequency of the electrical input power is provided by means of a converter or inverter, and wherein a frequency of the electrical output power varies in accordance with the frequency of the electrical input power when the wind turbine is rotating.

24. The method according to claim 14, wherein transferring the electrical input power from the nacelle to the hub is performed while the hub is stationary.
